(19) United States
(12) Patent Application Publication
(10) Pub. No.: US 2023/0198356 A1
(43) Pub. Date: Jun. 22, 2023

(54) METHOD AND DEVICE FOR FORMING WINDING ELEMENTS

(71) Applicant: Gehring Technologies GmbH + Co. KG, Ostfildern (DE)

(72) Inventors: Felix Wirth, Karlsruhe (DE); Jürgen Fleischer, Karlsruhe (DE); Pier Vai, POMPIANO (IT); Fabrizio Giuradei, LONATO DEL GARDA (IT); Federica Forte, BRESCIA (IT)

(73) Assignee: Gehring Technologies GmbH + Co. KG, Ostfildern (DE)

(21) Appl. No.: 17/642,097

(22) PCT Filed: Sep. 11, 2020
(86) PCT No.: PCT/EP2020/075549

§ 371 Date: Jan. 12, 2023

(30) Foreign Application Priority Data
Sep. 12, 2019 (DE) 10 2019 124 477.3

(51) Int. Cl. H02K 15/04; B21F 3/02

(52) U.S. Cl. CPC H02K 15/0421; B21F 3/02

(57) ABSTRACT

The invention relates to a method and device (10) for forming winding elements, in particular hairpin winding elements, from a conductor piece (12).

The invention relates to a method for forming winding elements, in particular hairpin elements. The invention also relates to a device for forming winding elements.

During the production of electromotors for traction engines, individual winding elements (hairpins) are created that are further processed to create a stator winding. In order to achieve greater efficiency of electrical machinery based on a greater fill level of the groove, hairpin technology has transitioned from round to rectangular conductor cross sections. For the production of the winding elements, corresponding conductor segments must be separated from the continuous material and formed into suitable winding elements. The winding elements are then integrated into the stator and welded together following positioning on the stator.

In this application, a hairpin winding element (so called due to it being similar in form to a hairpin) is an element comprising two parallel sides and an arch-formed segment that connects these two sides. In particular, a hairpin can have a U-formed profile. The connecting segment can have a three-dimensional course with constant and variable courses of the radii, meaning that parts of the connecting segment protrude from the level of the two sides.

The conductor pieces are by default normally formed into winding elements by one or more different bending stations (2D or 3D bending stations). This makes it possible to form the conductor pieces into the forms required for installation on the stator.

DE 10 2009 025 988 A1 describes a device for freely forming hollow profiles.

US 2003/0 029 215 A1 describes a bending device for flat wires.

Modern devices normally require calibration during operation. In other words, the forming influences or bending moment applied to the conductor pieces during the forming method are conventionally regulated during calibration processes via the creation of a multitude of formed conductor pieces, whereby, following each formed conductor piece in the calibration processes, it is normally inspected for correct forming as part of a separate testing procedure (e.g., by applying multiple hairpins in a stator core), and the forming influences are adapted to this separate testing procedure.

The invention aims to facilitate the affordable production of winding elements, in particular wire specifications, i.e., wire length, with various forms, whereby as little waste as possible is generated during the beginning of production in particular. Furthermore, the most consistent product quality possible must be ensured.

The invention achieves this with a procedure for forming winding elements, in particular hairpin winding elements, made from conductor pieces in accordance with the characteristics specified in claim 1.

Accordingly, the method comprises: forming of a conductor piece into an actual form by means of a forming device that exerts forming influences on the conductor piece in order to reform it, in particular via kinematic position changes. In other words, the conductor piece is converted from an initial form to an actual form via the forming method. The forming method is conducted by means of the forming device. The forming device exerts forming influences on the conductor piece. These forming influences are typically bending moment and torque moment. In other words, during the forming method, the conductor piece is bent and additionally or alternatively twisted in order to convert the work piece from the initial form to the actual form.

Determining the actual form of the conductor piece via a detection device. The detection device determines the three-dimensional course of the formed conductor piece, its three-dimensional form, its actual form resulting from the forming. Typically the detection device is a device for machine viewing, in particular a line scanner, a stereoscopic device or a sort of 3D scanner.

Determining a deviation between the actual form and a desired target form. The measured actual form is compared to a pre-defined target form. This comparison is used to determine whether there is a discrepancy between the actual form and the target form. This means it determines whether the forming method has transitioned the conductor piece into the target form, or if the form resulting from the forming method (actual form) differs from the desired (target) form.

Adjusting the forming influences used during the forming method based on any discrepancy discovered between the actual form and the target form. If a discrepancy is determined during the aforementioned comparison, the forming influences are adjusted to compensate for the discrepancy as much as possible. In other words, an error in the achieved form (discrepancy between actual form and target form) of the conductor piece is remedied in that the forming influences are adjusted to suit the conductor piece. For example, the bending moment and torsional moment used for forming the conductor piece are reconfigured. This makes the forming method increasingly accurate, whereby this method improvement is performed automatically and can also consider changes to the method parameters. A specific operating state (e.g., certain bending and torsional moments) is not set and performed continuously without adaption. Rather, the method is always being improved in the event of a discrepancy to achieve the desired target form.

The actual form can be determined as a variety of measurement points or curves that describe the contour of the conductor piece. Accordingly, the target form can also be available in the form of multiple points that describe the contour of the conductor piece.

It may be possible for rotationally symmetrical conductor pieces to be formed during the method. This invention also allows the conductor pieces that are being formed to not comprise a rotationally symmetrical cross section (orthogonal to the respective length).

The adjustment of the forming influences can be performed during the forming of the conductor piece, and the remainder of the forming method can be conducted under the new conditions. This means that a discrepancy known when the forming began can be considered during the forming method and the remainder of the forming method can be adjusted accordingly. The resulting, formed conductor piece can either (e.g., in the event of large discrepancies) be discarded or deemed still usable if the forming influences are configured. Even if the conductor piece is separated for disposal, the method provided by this invention still has an advantage over adjustment that only applies to the next conductor piece, as the forming influences are already correctly set when the next forming method of a conductor piece begins because, for example, multiple adjustment cycles of the forming influences have been able to take place during the forming of an individual conductor piece.

However, adjustment of the forming influences can also only take place following the forming of an initial conductor piece, and a forming method of a second (later, but not immediately subsequent) conductor piece can be conducted with the adjusted forming influences. For example, any various discrepancies at different points of the form of the conductor piece can thereby be considered, allowing for a more precise adjustment of the forming influences if necessary. It may be possible for the initial conductor piece to be formed and then “measured” with the detection device (determining the actual form), and the discrepancy from the target form to be determined, while another conductor piece is being formed. If the forming of the next conductor piece is completed with the same forming influences as the initial conductor piece, the forming method of the second conductor piece is conducted with the adjusted forming influences. Determination of the actual form and comparison with the target form, determination of the discrepancy, and adjustment of the forming influences, preferably occur within a time frame shorter than the time required to reform a conductor piece.

The (adjusted) forming influences used when forming the conductor piece can be determined based on a model, whereby the model specifies the forming influences (e.g., exerted bending and torsional moment) depending on the target form (desired form) and characteristic parameters (e.g., bend resistance) of the conductor piece. For example, calculations based on the elementary theory of bending can be included. The advantage of this is that it pursues a predictive approach that goes beyond a mere reaction in the adjustment, and considers knowledge of the forming behavior of the conductor piece, allowing for a more precise and faster adjustment.

The forming influences used when forming the conductor piece can also be adjusted proportionally to the difference determined between the actual form and the target form.

In the event of a discrepancy between the actual form and the target form, the characteristic parameters of the conductor piece upon which the model is based can be adjusted during a model adjustment method such that the model specifies the actual form (known and thus fixed) based on the exerted forming influences (known and thus fixed) and the adjusted characteristic parameters (adjustable parameters during this method). In an adjusted forming step, the adjusted forming influences (adjustable parameters during this method) can be specified for the further forming (rest of the conductor piece or next conductor piece) based on the model (correlation between initial form, forming influences, characteristic parameters, target form) and adjusted characteristic parameters (known and thus fixed) as well as the target form (known and thus fixed).

Initial values for the characteristic parameters used in the model can be determined by means of a test forming method with specified test forming influences on a test conductor piece with the same characteristic parameters as the conductor pieces to be formed in the future, while using the forming device. The forming influences are typically less complex than the real forming influences used to create a hairpin. Initial values can also be determined via tensile and/or bending tests in a separate testing device.

For example, a test conductor piece can be subjected to single bending at a certain angle, and a test conductor piece can be subjected to torsion at a certain angle. The resulting forming of the test conductor piece can be used to derive corresponding initial values for the characteristic parameters. The resulting actual form (following the test forming method) of the test conductor piece is determined, and initial values for the characteristic parameters are determined and applied to the model to determine the forming influences as an initial point based on the actual form of the test conductor piece.

The forming influence can be a free-forming bending device that can reform the conductor pieces arbitrarily and three-dimensionally.

In particular, the forming of the conductor piece can involve:
Insertion of the conductor piece into a transport device equal to the lengthwise direction of the conductor piece, through a guide, whereby the guide comprises an outlet opening, the aperture margins of which contact the exterior of the conductor piece on both sides from two vertically opposite directions when the conductor piece is inserted;
Insertion of the conductor piece protruding out from the opening into a forming unit following the outlet opening, comprising a forming opening, on the edge of which are multiple forming segments, whereby the forming segments contact the exterior of the conductor piece from both sides from two vertically opposite directions; and
Forming of the conductor piece by moving the conductor through the forming opening with consistent alteration of the orientation of the forming segments relative to the aperture margins of the guide, whereby the forming segments tilt around at least one pivot axis orthogonal to the direction of transport during the forming method, relative to the aperture margins, and are translationally moved along at least one plane, the surface normal of which is the pivot axis, whereby, in the event of a reorientation of the forming segments relative to the aperture margins of the guide during the forming of the forming segment on an inner side of an arch to be formed on the conductor, it remains unaltered in its relative position opposite the aperture margins. In other words, it is possible for the forming segment on the inner side of a bend to remain immobile relative to the guide with this type of method. The bending occurs by moving the forming segment opposite the unmoved forming segment.

The method facilitated by this invention allows for a particularly voltage-free forming, required for insulated conductor pieces in particular. Furthermore, particularly tight curvature radii and highly complex geometries can be thereby realized. As explained above, the conductor passes both through the outlet opening as well as the forming opening in a precisely specified orientation, as it is rail-guided in the outlet opening and the forming opening by the respective, bilateral contact with the conductor piece on both sides from the two vertically opposite directions. By changing the alignment of the forming opening with the outlet opening by tilting during the forming method, the conductor is forcefully bend and/or twisted.

The forming device is used to form the conductor piece into the desired form, to which end the forming segments or forming device as a whole are tilted. In order to prevent clamping of the conductor piece in the forming device, and thus unwanted deformations or damage to the conductor piece when the forming device is pivoted around the pivot axes orthogonal to the direction of transport, the forming device or its forming segments are moved in a plane, the surface normal of which is the pivot axis, at the same time as the tilt (compensation of pivot movement). In other words, a pivot or rotation occurs to reform the conductor piece, while a translational movement also occurs to compensate for the misalignment in the pivot plane resulting from the pivot movement (misalignment of the forming opening based on the outlet opening of the guide). Such translational compensation is not necessary when tilting around the direction of transport.

Maintaining the position of the inner forming segment is beneficial to the forming method of the conductor piece, as (from the perspective of the direction of transport) the opening cross section of the forming opening is largely or completely altered on the side facing away from the forming (“outer curve side”). The “hole misalignment” resulting from the pivot is thus largely or completely compensated. This makes the forces generated by the forming relatively weak. The clamp tilt of the forming device is also low.

The conductor is thus initially inserted into a guide, whereby the guide comprises an outlet opening, the aperture margins of which contact the exterior of the conductor on both sides from two vertically opposite directions during insertion of the conductor (in other words, from four sides). The bilateral contact with the conductor on both sides from the two vertically opposite directions means that the conductor is essentially rail-guided in the outlet opening. In other words, it passes into the outlet opening in an orientation precisely specified by the contact.

Such a rail guidance is provided in the forming opening via the bilateral contact with the conductor piece from the two vertically opposite directions. In other words, it passes into the forming opening in an orientation precisely specified by the contact.

Forming is caused by movement of the conductor piece through the forming opening, with simultaneous alteration of the orientation of the forming segments relative to the aperture margins of the guide. The forming segments (or, in other words, the forming device as a whole) are pivoted around at least one pivot axis orthogonal to the transport direction, relative to the aperture margins, and translationally moved along at least one place, the surface normal of which is the pivot axis. The overlaid translation can remedy the hole misalignment, and the position of the forming opening or its forming segment on the inside of a curve can be kept constant relative to the guide or its aperture margins.

As explained above, the conductor piece passes into the outlet opening as well as the forming opening in a precisely specified orientation, as it is rail-guided in the outlet opening and forming opening by the respective, bilateral contact with the conductor piece from the two vertically opposite directions.

The invention also entails a device for forming winding elements, in particular hairpin winding elements, from a conductor piece, comprising:

a guide, whereby the guide comprises an outlet opening, the aperture margins of which are designed and arranged to contact the exterior of the conductor piece from two vertically opposite directions on both sides during insertion through the outlet opening;

a forming unit located at the outlet opening and comprising a forming opening, on the edge of which are multiple forming segments, whereby the forming segments are designed and arranged to contact the exterior of the conductor piece from two vertically opposite directions on both sides during insertion through the forming opening;

whereby the device comprises at least one initial pivot unit and at least one initial compensation unit that interact with the forming unit in such a manner that the forming segments can be pivoted around at least one initial pivot axis running orthogonally to the transport direction and relative to the aperture margins, and can be translationally moved along at least one plane, the surface normal of which is the pivot axis, whereby the device also comprises a second pivot unit and a second compensation unit (remedies the misalignment caused by the pivot motion) that interact with the forming unit such that the forming segments can be pivoted around a second pivot axis running orthogonally to it (and different from the first pivot axis), relative to the aperture margins, and can be translationally moved along at least one plane, the surface normal of which is the second pivot axis, and whereby the device also comprises a pivoting mechanism that interacts with the forming unit such that the forming segments can be pivoted around at least one pivot axis corresponding to the transport direction and relative to the aperture margins, whereby

the device also comprises a detection device that is configured and arranged such that it determines an actual form of the conductor piece generated by the forming method via machine viewing when the conductor piece has passed through the forming unit.

The device can comprise a monitoring device that is designed and configured to specify the forming influences exerted on the conductor pieces by the forming unit (pivot and compensation movements), whereby the monitoring device is also designed and configured to perform a method in accordance with the design forms described here and hereafter.

The detection device can be configured and arranged to determine the actual form of a formed conductor piece when it exits the forming segments of the forming unit, or during exit from the forming segments of the forming unit. Such a detection device can facilitate an adjustment of the forming influences during forming of a conductor piece.

The detection device can be configured and arranged to determine the actual form of a formed conductor piece after completion of the forming method of the conductor piece.

Preferably, the method facilitated by the invention has a target form for reference, comprising a three-dimensional length. The target form preferably comprises bending radii in at least certain areas that change continuously along the length of the conductor piece.

In particular, the method facilitated by the invention considers the rebound characteristics of the conductor pieces based on the model.

The forming method of the conductor pieces results from a continuously changing relative position of two openings that rail-guide the conductor pieces and through which the conductor pieces are moved, specifically pushed.

The conductor pieces are preferably made from a solid material coated with insulation. The conductor pieces preferably comprise a largely rectangular cross section, in particular with rounded corners.

In particular, the forming method facilitated by the invention is a kinematic bending method with changing bending radii. The target form in particular is a three-dimensional form, meaning that it does not run along one continuous plane. Non-constant free-forming bending radii are used during the forming method. The forming method does not take place along one constant bending plane.

The invention is described in greater detail by the figures below, whereby the equivalent or functionally equivalent elements are only once given a reference number if necessary. They show:

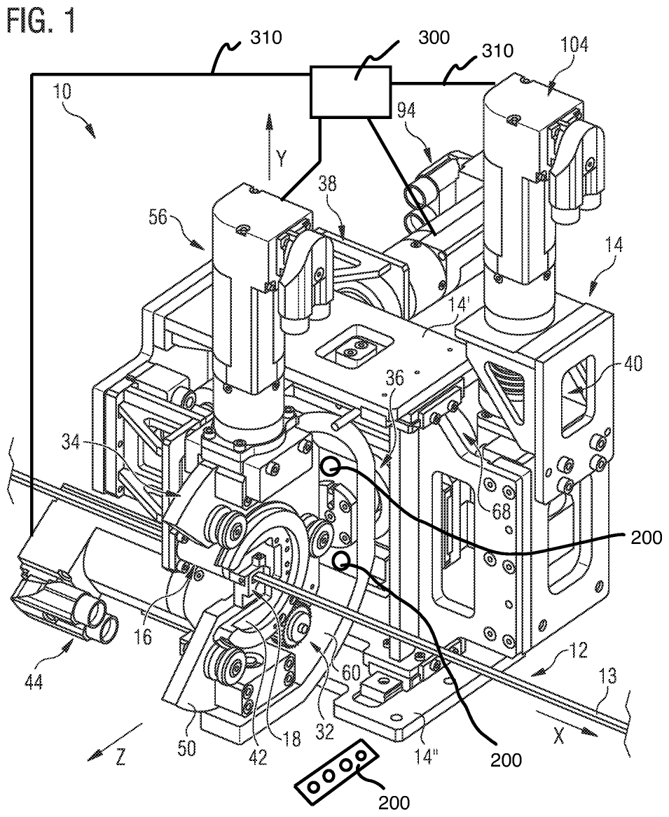

FIG. 1 a variant of a device for forming hairpin winding elements from a conductor piece, front view;

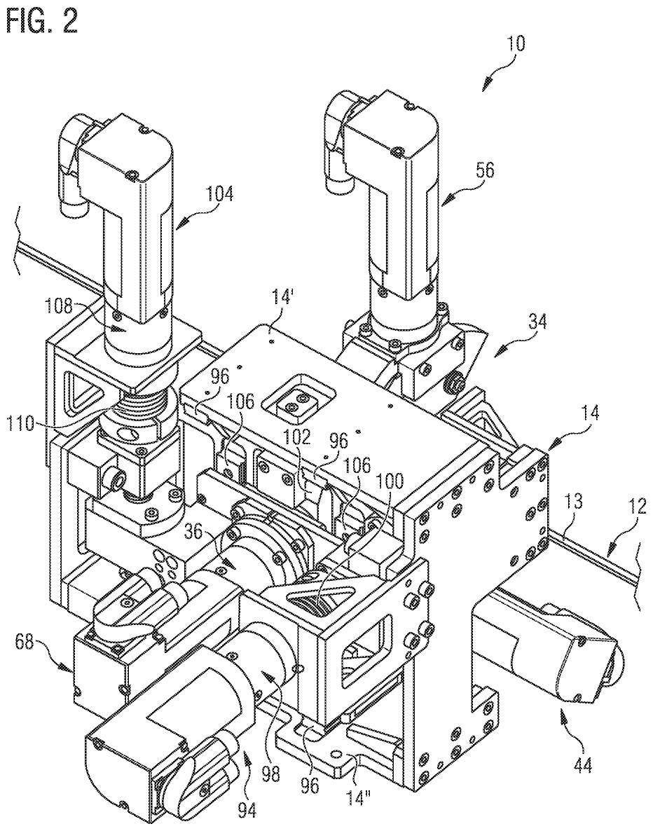

FIG. 2 the device from FIG. 1, rear view;

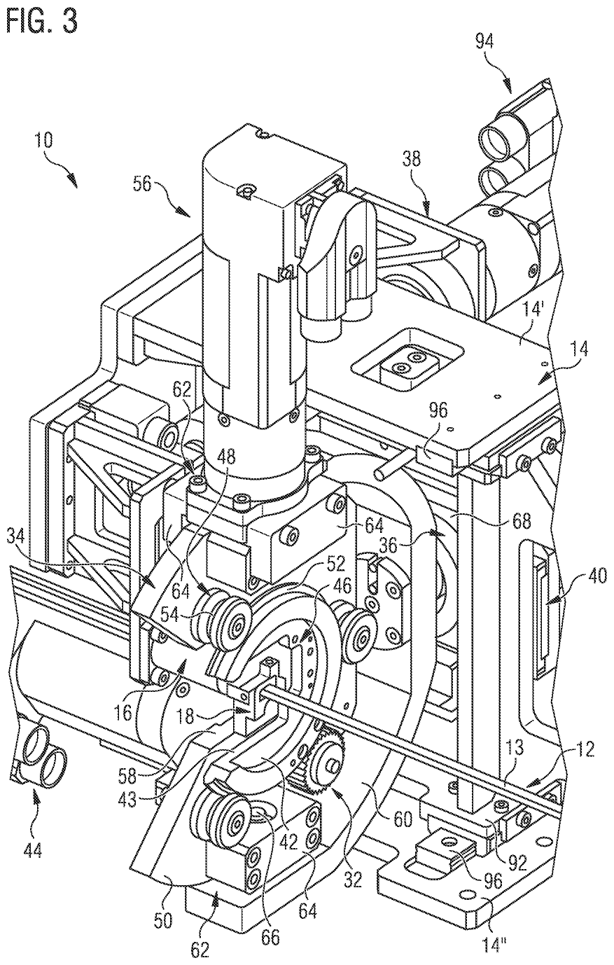

FIG. 3 the device from FIG. 1, partial and enlarged front view;

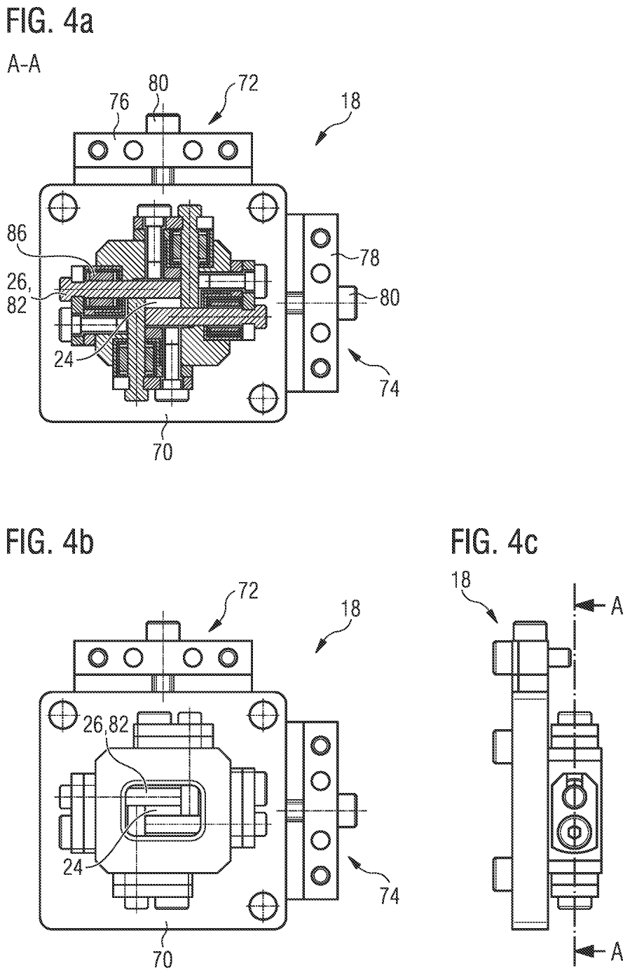

FIG. 4a-c a variant of a forming device of the device from FIG. 1, multiple views;

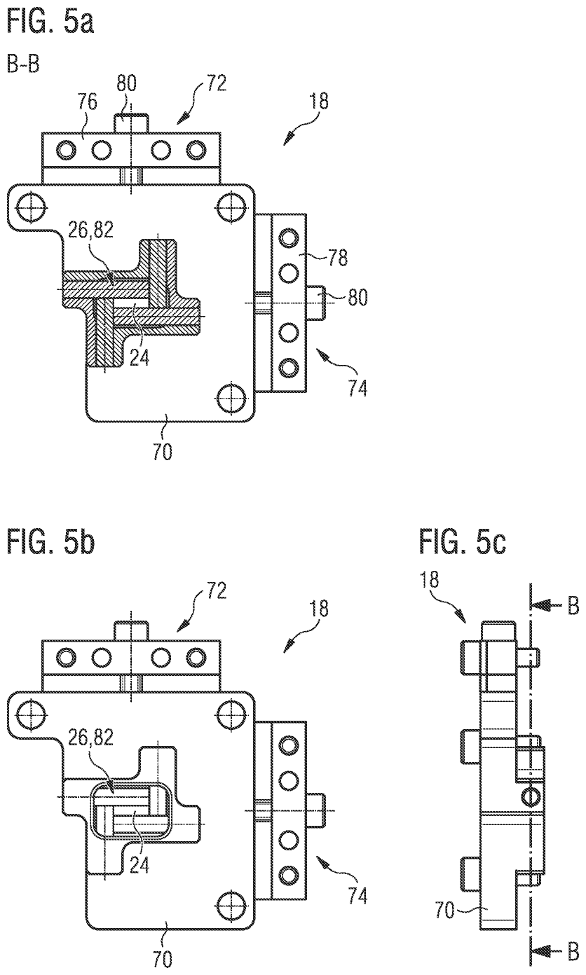

FIG. 5a-c a variant of a forming device of the device from FIG. 1, multiple views;

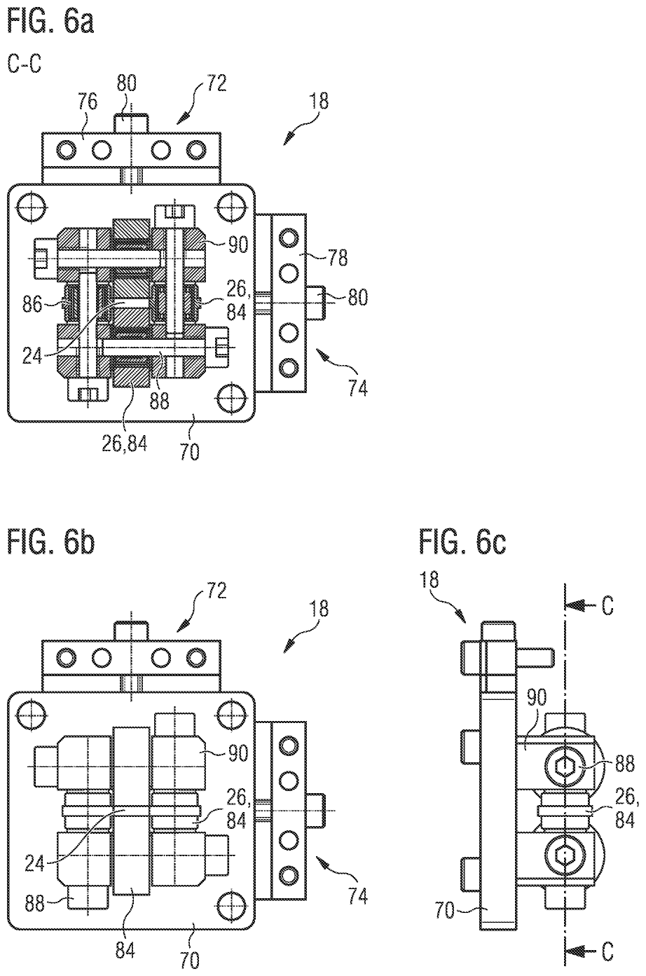

FIG. 6a-c a variant of a forming device of the device from FIG. 1, multiple views;

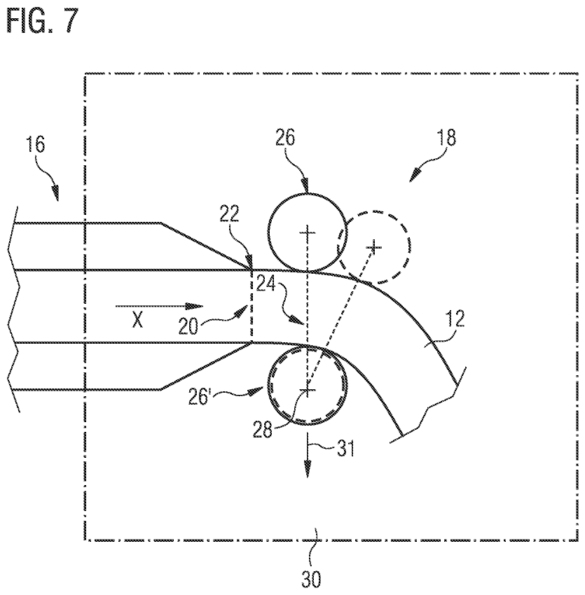

FIG. 7 a reorientation of the forming segments relative to the aperture margins of the guide, schematic depiction;

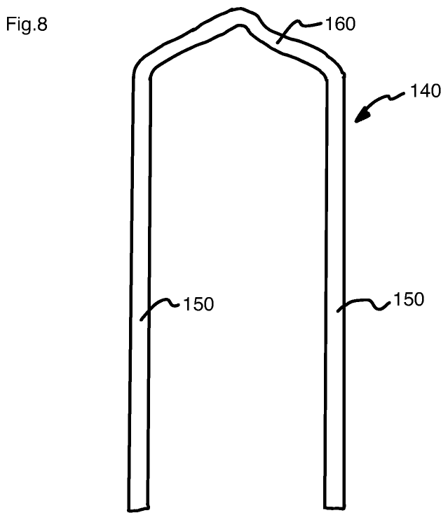

FIG. 8 a hairpin;

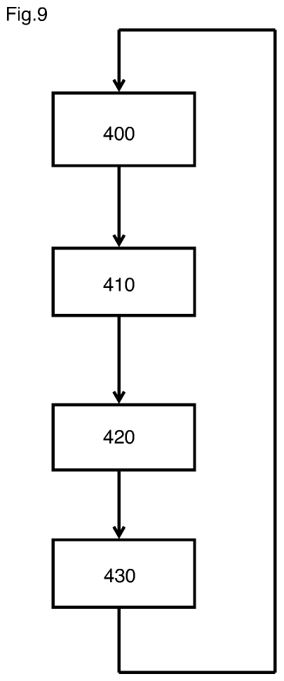

FIG. 9 a possible sequence of the method facilitated by the invention;

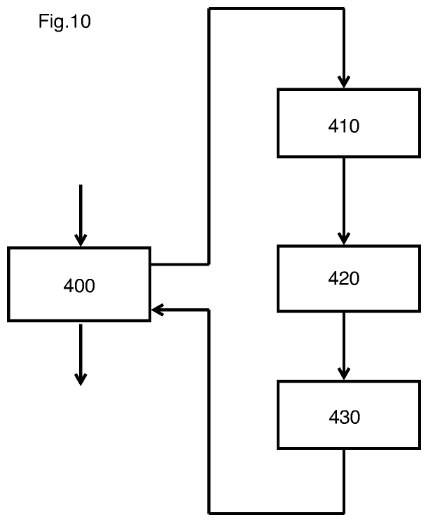

FIG. 10 a possible sequence of the method facilitated by the invention;

FIG. 11 a model for conducting the method facilitated by the invention, whereby forming influences are determined; and

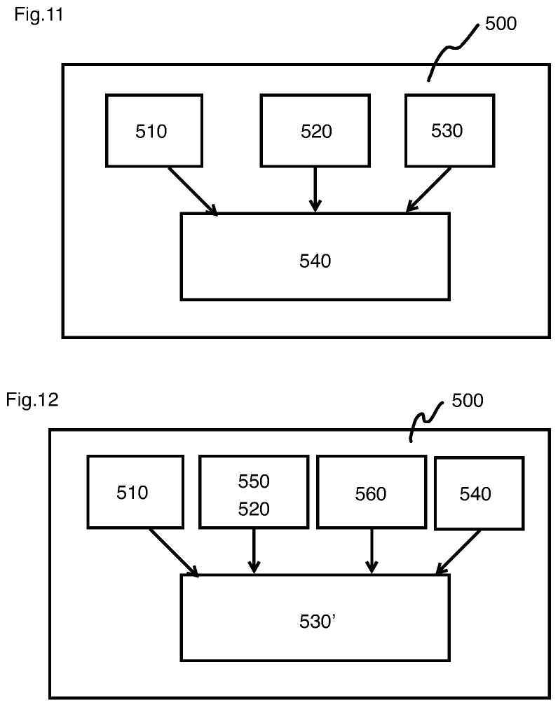

FIG. 12 the model for conducting the method facilitated by the invention, whereby adjusted characteristic parameters are determined.

FIG. 1 shows a device (10) that constitutes a forming device for forming, for example, a hairpin winding element from a conductor piece (12). The conductor piece (12) runs lengthwise across a longitudinal direction (X direction), and comprises an outer side (13) along the longitudinal direction. The components of the device (10) are coupled with or fastened to a bearing frame (14).

The device (10) exhibits a guide (16) (partially obscured in FIG. 1) as well as a forming unit (18) through which the conductor piece (12) is guided. The forming unit (18) can be moved relative to the guide (16) via multiple pivots and compensators, which facilitates the forming of the conductor piece (12) guided through the guide (16) and forming unit (18) into a (for example) hairpin winding element. This is described in detail below, whereby the spatial axes (X-axis, Y-axis, Z-axis) in FIG. 1 are used for reference. The X-axis extends along the longitudinal length of the conductor piece (12), the Y-axis extends from the X-axis orthogonally upward (vertically upward in FIG. 1), and the Z-axis extends orthogonally from the X-Y plane (diagonally downward to the left in FIG. 1).

As indicated, the device (10) comprises a guide (16) (partially obscured in FIG. 1) that comprises an outlet opening (20) (see FIG. 7). The aperture margins (22) of the outlet opening (20) are designed and arranged to contact the conductor piece (12) on both sides from two vertically opposite directions (from four sides total) when the conductor piece (12) passes through the outlet opening (20) (only implied in FIG. 7).

As indicated previously, the device (10) comprises a forming unit (18) that, in the direction of transport of the conductor piece (12) (X-axis), is located immediately after the outlet opening (20) and that comprises a forming opening (24). There are four forming segments (26) on the edge or edges of the forming opening (24) that are designed and arranged to contact the outer side (13) of the conductor piece (12) on both sides from two vertically opposite directions (from four sides total) when the conductor piece (12) passes through the forming opening (24). The four forming segments (26) are designed and arranged such that the forming opening (24) is as rectangular as possible.

The device (10) comprises at least one pivoting mechanism and at least one compensator device that interact with the forming unit (18) such that the forming segments (26) can be pivoted around at least one pivot axis (28) and moved along at least one plane (30), the surface normal of which is the pivot axis (28), relative to the aperture margins (22) (illustrated in FIG. 7).

In this example variant, the device (10) comprises an initial pivoting mechanism (32), a second pivoting mechanism (34), a third pivoting mechanism (36), an initial compensator device (38) and a second compensator device (40).

The initial pivoting mechanism (32) comprises an initial, inner suspension (42) on which the forming unit (18) is fastened or screwed. The inner suspension (42) can be pivoted around an initial pivot axis (X-axis) that runs along the transport direction of the conductor piece (12), via an initial drive device (44). The conductor piece (12) can be formed around the transport direction (X-axis) (torsion of the conductor piece (12) around the X-axis). As there is no misalignment in this case (middle longitudinal axes of the outlet opening (20) and the forming opening (24) are congruent or are both on the X-axis), no compensator device is required for the initial pivoting mechanism (32).

The inner suspension (42) (main disc 42) is disc-formed and comprises a recess (43) that is open on the side (annulus segment). The recess (43) provides room for the forming of the conductor piece (12) (e.g., when bending at 180°). The inner suspension (42) includes fastening segments (46) for the forming unit (18) that, as fastening points, comprise drill holes or passages with inner threads for fastening screws (without reference numbers). The inner suspension (42) can be pivoted with multiple bearings (48) that, based on the transport direction (X-axis), can be pivoted at 120° (for example). These bearings (48) are fastened onto the middle suspension (50), as described below.

The inner suspension (42) comprises a radially protruding flange (52) on its outer circumference that corresponds with a groove (54) in each of the bearings (48). The first drive device (44) can comprise a motor, such as a (brushless) electrical motor, that can drive the inner suspension (42) around its pivot axis (X-axis). The drive device (44) and the inner suspension (42) are coupled via a gear connection or a spiral gear. The motor shaft of the drive device (44) and the pivot axis (X-axis) are oriented parallel to each other.

The second pivoting mechanism (34) comprises a second, middle suspension (50) that can be pivoted around a second (in this case, vertical) pivot axis (Y-axis) orthogonal to the transport direction (X-axis) via a second drive device (56) (pivot movement around the Y-axis). This facilitates a forming of the conductor piece on a plane (“2D forming”, i.e., forming into a flat hairpin).

The inner suspension (42) and the forming unit (18) fastened to it are located at the middle suspension (50). The middle suspension (50) (second disc 50) is disc-formed and comprises a recess (58) (flat annulus segment). The recess (58) provides room for the forming of the conductor piece (12). The bearings (48) are fastened onto the middle suspension (50) via a screw connection. The first drive device (44) for the inner suspension (42) is also fastened onto the middle disc (50), such as via screw connections.

The pivot movement (rotation) of the middle suspension (50) is directly induced by the motor shaft (no reference number) of the second drive device (56). The second drive device (56) comprises a motor, such as a (brushless) electrical motor, whereby the second pivot axis (Y-axis) and the middle longitudinal axis of the motor shaft are congruent. The second drive device (56) is fastened onto an outer suspension (60), as described below. A fastening of the middle suspension (50) onto the other suspension (60) is facilitated by bearing units (62), which allow a pivot movement around the second pivot axis (Y-axis). The bearing units (62) comprise multiple fastening segments (64), bolts (66), and roller bearings (not pictured).

The third pivoting mechanism (36) comprises a third, outer suspension (60) that can pivot around a third (vertical here) pivot axis (Z-axis) orthogonal to the transport direction via a third drive device (68) (pivot movement around the Z-axis). This makes a forming of the conductor piece (12) on another plane possible (“2D forming”), e.g., a vertical plane based on the frame (14) of the device (10) (X-Y axis). Together with the second pivoting mechanism (34), a three-dimensional forming of the conductor piece (12) to a winding element is thus possible (“3D forming”).

The middle suspension (50) and the inner suspension (42) are located at the outer suspension (60) with the fastened forming unit (18). The outer suspension (60) is an annulus segment and comprises a C-formed cross section. The bearing units (62) and second drive device (56) for the middle suspension (50) are fastened onto the outer suspension (60).

The pivot movement (rotation) of the outer suspension (60) is directly induced by the motor shaft (no reference number) of the third drive device (68). The third drive device (68) comprises a motor, such as a (brushless) electrical motor, whereby the third pivot axis (Z-axis) and the middle longitudinal axis of the motor shaft of the third drive device (68) are congruent. The third drive device (68) is fastened onto the frame (14) via the first compensator device (38) and/or the second compensator device (40), as described below.

The forming unit (18) is designed as an interchangeable tool unit (see FIGS. 4 to 6). This means that the matching forming unit (18) can be selected and adjusted to the forming.

The forming unit (18) comprises a plate-formed holding structure (70) (base plate 70) with drill holes/passages for fastening onto the inner suspension (42). The forming unit (18) comprises two adjustment devices (72, 74) for fine-tuning the forming unit (18) at the level of the base plate (70). To this end the forming unit (18) comprises adjustable stops (76, 78) relative to the base plate (70). Each stop (76, 78) can be adjusted and fixed relative to the base plate (70) with a fastening screw (80). Drill holes or passages with threads can be placed in the stop (76, 78) for fastening onto the inner suspension (42) (no reference number). The device (10) can comprise multiple different forming devices (18) or tool units, e.g., the device (10) can come with a set of different forming devices (18).

The forming segments (26) of the forming unit (18) are each formed by a pin (82) or a roll (84), which can optionally be located at the forming unit (18) via a roller bearing (86). Because of the rectangular cross section of the conductor piece (12), four forming segments (26) are provided.

In order to provide a forming unit (18) with a simple design, the pins (82) (without roller bearings) can be fastened on or in the base plate (70) (see FIG. 5). When the conductor piece (12) is guided through the forming opening (24), the pin (82) does not turn with it or only does so slightly. Solutions of higher structural quality can be achieved with variants with roller bearings. This means the pins (82) can be stored on or in the base plate (70) via roller bearings (86) (see FIG. 4a). Rollers (84) can also be stored on or in the base plate (70) via roller bearings (86) (see FIG. 6a). The rollers (84) or roller bearings (86) can be fastened with screws (88) onto bearing blocks (90) fastened onto the base plate (70).

As already indicated, the device (10) comprises a frame (14) as a bearing structure, whereby the third pivoting mechanism (36) is coupled with the frame (14) via the first compensator device (38) and the second compensator device (40).

The first compensator device (38) comprises an initial slider (92) that can move horizontally along the frame (14) and can be driven by a fourth drive device (94), meaning that the forming unit (18) can be moved along the pivot axis of the third pivoting mechanism (Z-axis). The lateral misalignment (misalignment in Z-direction) relative to the conductor piece (12) can be compensated as an effect of the pivot movement around the Y-axis.

The first slider (92) can be coupled with the frame (14) via four linear guides (96) (e.g., with chain ball). Two linear guides (96) are fastened to an upper frame segment (14′) and two linear guides are fastened to a bottom frame segment (14″). The first slider (92) can be moved along the linear guides (96) by the fourth drive device (94). The fourth drive device (96) can comprise a motor, such as a (brushless) electrical motor, and be fastened onto the frame (14). A spindle (98) is coupled with the motor shaft (ball roll spindle 98) that interacts with a nut (spindle nut, not pictured) fastened onto the first slider (92). The motor shaft of the fourth drive device (96) is coupled with the spindle (98) via a metal bellows coupling (100).

The second compensator device (40) comprises a second slider (102) that can move vertically relative to the frame (14) and that can be driven by a fifth drive device (104), meaning that the forming unit (18) can be moved along an axis (Y-axis) orthogonal to the pivot axis of the third pivoting mechanism (36) (Z-axis). This means that the vertical misalignment (misalignment in Y-direction) relative to the conductor piece (12) can be compensated as an effect of the pivot movement around the Z-axis.

The second slider (102) is coupled with the frame (14) via two linear guides (106) (e.g., with cage ball). The second slider (102) can be driven along the linear guides (106) via the fifth drive device (104). The fifth drive device (104) comprises a motor, such as a (brushless) electrical motor, and is fastened to the frame (14). A spindle (108) (ball roller spindle 108) is coupled with the motor shaft of the fifth drive device (104), which interacts with a nut (spindle nut, not pictured) fastened onto the second slider (102). The motor shaft is coupled with the spindle (108) via a metal bellows coupling (110).

The forming device (10) further comprises a detection device (200) or multiple detection devices (200) that are arranged and designed such that they determine an actual form of the conductor piece (12) resulting from the forming method via machine reading when the conductor piece (12) has passed through the forming unit (18). The detection device (200) as per this invention is a device for measuring three-dimensional form data of the formed conductor piece (12). The detection device (200) preferably measures the form optically. Line scanners, structured light systems, or stereoscopic detection devices can be used.

The forming device (10) further comprises a control device (300) that is designed and configured to specify the forming influences exerted on the conductor pieces (12) via the forming unit (18). In other words, the control device (300) controls the forming device (10) and specifies the tilt settings of the pivoting mechanisms (32, 34, 36) as well as the respective compensation movement by the compensator devices (38, 40). To this end the control device (300) controls the drive units (44, 56, 68, 94, 96, 104) assigned to the respective pivoting mechanisms (32, 34, 36) and compensator devices (38, 40). Connections (310) with the drive devices are indicated with symbols in FIG. 1. These can be designed in a variety of ways, e.g., wired or wireless.

The method for forming a preferably hairpin winding element (plug-in coil) from a conductor piece (12) that runs lengthwise along a longitudinal direction (X-axis) and comprises an outer side (13) along the longitudinal direction, is conducted as follows, using the forming device (10) as an example:

Forming a conductor piece (12) into an actual form. In other words, the conductor piece (12) is formed from its straight initial form into an actual form, such as that of the hairpin depicted in FIG. 8.

While doing so, the forming device (10) exerts forming influences on the conductor piece (12) in order to reform it. These forming influences are exerted by tilting the forming unit (18) relative to the guide (16) or its outlet opening (20). The aforementioned translational compensation movements may also be present in order to prevent a misalignment with the guide and the forming unit (18).

Determining the actual form of the conductor piece (12) with the detection device (200). The detection device (200) is capable of creating a 3D profile of the conductor piece. The measurement of the actual form of the conductor piece can be performed directly after it has exited the forming unit (18). It is also possible to use a detection device (200) that measures three-dimensionally the finished hairpin and thereby determines the actual form.

The method also comprises the determination of a deviation between the actual form and a desired target form. This determination of the deviation can be performed across the entire length of the finished, formed conductor piece (12) or, if a detection device (200) that measures the hairpin once it leaves the forming device (18) is used for example, locally or by segment as well.

The method also comprises the adjustment of the forming influences exerted during the forming method based on any deviation detected between the actual form and the target form. This adjustment can also be made following the complete forming of the conductor piece into a hairpin, or locally or by segment, once a deviation from the desired target form is detected.

In this example in particular, the conductor piece (12) is first passed through the guide (16). The aperture margins (22) of the outlet opening (20) contact the outer side (13) of the conductor piece (12) on both sides from two vertically opposite directions (from four sides) when the conductor piece (12) is passing through.

The conductor piece (12) protruding from the guide (16) is passed through the forming unit (18) with the forming opening (24) immediately following the outlet opening (20) (in the direction of transport of the conductor piece (12). The forming segments (26) contact the outer side (13) of the conductor piece (12) on both sides from two vertically opposite directions (from four sides).

The conductor piece (12) is formed due to the movement of the conductor piece (12) through the forming opening (24) with simultaneous alteration of the orientation of the forming segments (26) relative to the aperture margins (22) of the guide (16) or of the outlet opening (20). The forming segments (26) (or, in other words, the forming unit (18) as a whole) are tilted relative to the aperture margins (22) around the corresponding pivot axis (28) during the forming process, and moved along at least one plane (30), the surface normal of which is the pivot axis (28).

When the orientation of the forming segments (26) relative to the aperture margins (22) of the guide (16) is altered, the position of the forming segment (26) on the inside of the arch formed on the conductor piece (12) (inner radius) relative to the aperture margins (22) of the guide (16) is unchanged, and instead it remains in its position relative to the aperture margins (22). This practically compensates the “hole misalignment” caused by the tilting movement.

This aspect is illustrated in FIG. 7. The initial position of the forming unit (18) or forming segments (26) (continuous conductor piece (12) would not be formed) is drawn in FIG. 7 with solid lines. A potential forming position of the forming unit (18) or forming segments (26) (continuous conductor piece (12) is formed as depicted) is drawn with dashed lines. If the orientation of the forming unit (18) relative to the aperture margins (22) starting with the initial position (solid lines) occurs without compensation of the hole misalignment, the forming unit (18) would be tiled around a pivot axis that cuts the conductor piece (12) down the middle, which would result in the conductor piece (12) being strained by the forming segments (26) on two opposite sides (not pictured). This would result in a misalignment between the guide (20) and forming opening (24).

In order to prevent this, the forming unit (18) is not only tilted, but also translationally moved toward the inside of the forming (inner radius) (indicated by arrow 31) in the pivot plane (30), the surface normal of which is the pivot axis (28). This is done such that the forming segment (26′) on the inner side of the arch does not change its position relative to the aperture margins (22) during the forming. The overlaid pivot movement and translational compensation are thus essentially attuned to each other so that the forming segment (26′) does not perform a relative movement when tilting relative to the aperture margins (22).

The conductor piece is bent or twisted by the tilting of the forming segments (26). The exerted bending or torsion moments constitute the forming influences exerted on the conductor piece (12).

The detection device (200) determines the form of the conductor piece as it exits the forming unit (18).

The form information determined by the detection device (200) and the actual form of the conductor piece are transmitted to the control device (300). The control device (300) conducts a comparison between the form information determined by the detection device (200) and the actual form of the conductor piece after the forming method, with the desired target form. If a deviation is found, the control device (300) adjusts the forming influences. In other words, it alters the pivot position of the forming segments (26) for a specific bending or torsion, or changes the bending or torsional moments exerted on the conductor piece (12) for a specific bending or torsion.

This adjustment of the forming influences (bending and torsional moments) can be performed during the forming of a conductor piece, so that the rest of the conductor piece is processed with the new forming influences, or after the full forming method, so that the next conductor piece is processed with the adjusted forming influences.

FIG. 8 shows a hairpin (140) produced with the method and device described by the invention. The hairpin (140) comprises two parallel, straight sides (150) as well as a connecting segment (160) protruding from the level of the sides (150). Various bending and torsional moments were exerted on the previously straight conductor piece (12) when making the hairpin (140).

FIG. 9 illustrates a variant of the method described by the invention.

In one step (400), a conductor piece (12) is formed into an actual form via the use of a forming device (10) that exerts forming influences on the conductor piece (12) to reform it.

In one step (410), following step (400) in this example, the actual form of the conductor piece (12) is determined by means of a detection device (200), in particular a detection device (200) for machine viewing.

In one step (420), following step (410) in this example, a deviation between the actual form and a desired target form is determined.

In one step (430), following step (420) in this example, the forming influences are adjusted on the basis of any detected deviation between the actual form and the target form. After completion of step (430), another conductor piece (12) is led through another forming method in another step (400).

In the example of FIG. 9, the forming influences are adjusted after forming of the entire conductor piece (12). The actual form of the conductor piece (12) can be determined either during or after the forming.

FIG. 10 illustrates another variant of the method described by the invention.

In one step (400), a conductor piece (12) is formed into an actual state via the use of a forming device (10) that exerts forming influences on the conductor piece (12) to reform it.

In one step (410), during step (400) in the example of FIG. 10, the actual form of the conductor piece (12) is determined by means of a detection device (200), in particular a detection device (200) for machine viewing.

In one step (420), following step (410) and during step (400) in the example of FIG. 10, a deviation between the actual form and a desired target form is determined.

In one step (430), following step (420) and during step (400), the forming influences are adjusted on the basis of any detected deviation between the actual form and the target form. Steps (410) and (420) are continuously performed during the forming, i.e., during step 400. Once a deviation between the actual form and the target form is detected locally, the corresponding forming influences are adjusted in step (430), which then commences. After completion of step (430), the conductor piece (12) is further formed, i.e., step (400) continues. After completion of step (400), another conductor piece (12) is led through another forming method in another step (400).

In the example of FIG. 10, the forming influences are adjusted during the forming of the conductor piece (12). The actual form of the conductor piece (12) is determined accordingly during the forming.

FIGS. 11 and 12 illustrate a model (500) for calculating the forming influences (540). In order to calculate the forming influences (540), the model (500) considers as parameters at least the initial form (510), the desired target form (520), and characteristic parameters (530) of the conductor piece (12) to be formed.

In order to determine the forming influences (540) for an initial forming method, an estimate or initial values determined during a test run can be applied for the characteristic parameters (530).

If a deviation (550) is determined between the measured actual form (560) and the target form (520), the characteristic parameters (530) are adjusted so that adjusted characteristic parameters (530′) are used in the continuation of the calculation depicted in FIG. 11 instead of the initial value for the characteristic parameters (530).

The calculation of the adjusted characteristic parameters (530′) is illustrated in FIG. 12.

The adjusted characteristic parameters (530′) are calculated via the model, whereby the model considers at least the initial form (510) and the forming influences (540) exerted during the forming method (previously determined as per FIG. 11), and either the originally planned target form (520) and determined deviation (550) or the measured actual form (560).

The model (500) is based on a reversible mathematical correlation between the individual parameters.

Preferably the method described by the invention is based on a target form comprising a three-dimensional length. Preferably the target form comprises bending radii that continuously change throughout the length of the conductor piece.

1. Method for forming winding elements, in particular hairpin winding elements from conductor pieces (12), in particular whereby the conductor pieces (12) in their initial state run lengthwise along a longitudinal direction (X), whereby the method comprises:
The forming of a conductor piece (12) into an actual form (560) by means of a forming device (10) that exerts forming influences (540) onto the conductor piece (12) to reform it;
Determining the actual form (560) of the conductor piece (12) by means of a detection device (200), in particular a detection device (200) for machine viewing;
Determining a deviation (550) between the actual form (560) and a desired target form (520);
Adjusting the forming influences (540) used during the forming based on any detected deviation (550) between the actual form (560) and the target form (520).

2. Method as per claim 1, characterized in that the forming influences (540) are adjusted during the forming of a conductor piece (12), and the remainder of the forming method is conducted with the adjusted forming influences (540).

3. Method as per claim 1, characterized in that the forming influences (540) are adjusted following the forming of an initial conductor piece (12), and a forming method of a second conductor piece (12) is conducted with the adjusted forming influences (540).

4. Method as per one of the preceding claims, characterized in that the forming influences (540) used during the forming of the conductor piece (12) are determined based on a model (500), whereby the model (500) specifies the forming influences depending on the target form (520) and characteristic parameters (530) of the conductor piece (12).

5. Method as per the preceding claim, characterized in that, in the event of a deviation between the actual form (560) and the target form (520), the characteristic parameters (530) of the conductor piece (12) underlying the model (500) are adjusted in a parameter configuration step such that the model (500) specifies the actual form (560) based on the exerted forming influences (540) and the adjusted characteristic parameters (530), whereby the adjusted forming influences (540) are specified for the remainder of the forming based on the model (500) and the adjusted characteristic parameters (530′) as well as the target form (520).

6. Method as per the preceding claim, characterized in that initial values for the characteristic parameters (530) used in the model are determined in that the forming device (10) with specified test forming influences is used to conduct a test forming method on a test conductor piece that comprises the same characteristic parameters (530) as the conductor pieces (12) to be formed in the future, and the resulting actual form (560) of the test conductor piece is determined, and the characteristic parameters (530) are determined based on the actual form (560) of the test conductor piece and the test forming influences used, and applied to the model to determine the forming influences (540) as a starting point.

7. Method as per one of the preceding claims, characterized in that the forming device (10) is a free-forming bending device.

8. Method as per one of the preceding claims, characterized in that the forming of the conductor piece (12) comprises:
Passing the conductor piece (12) in a direction of transport, which corresponds to the longitudinal direction (X) of the conductor piece, through a guide (16), whereby the guide (16) comprises an outlet opening (20), the aperture margins (22) of which contact the outer side (13) of the conductor piece (12) on both sides from two vertically opposite directions;
Passing the conductor piece (12) protruding from the guide (16) through a forming unit (18) following the outlet opening (20), comprising a forming opening (24), on the edge of which are multiple forming segments (26), whereby the forming segments (26) contact the outer side (13) of the conductor piece (12) on both sides from two vertically opposite directions; and
Forming the conductor piece (12) by moving the conductor piece (12) through the forming opening (24) while changing the orientation of the forming segments (26) relative to the aperture margins (22) of the guide (16), whereby the forming segments (26) pivot relative to the aperture margins (22) around at least one pivot axis (28, Y, Z) orthogonal to the transport direction during the forming process, and are translationally moved along at least one plane (30), the surface normal of which is the pivot axis (28, Y, Z), whereby
when changing the orientation of the forming segments (26) relative to the aperture margins (22) of the guide during the forming (16), the forming segment (26′) on an inner side of an arch to be formed on the conductor piece (12) remains unchanged in its position relative to the aperture margins (22).

9. Device (10) for forming winding elements, in particular hairpin winding elements, from a conductor piece (12), comprising:
a guide (16), whereby the guide (16) comprises an outlet opening (20), the aperture margins (22) of which are designed and arranged to contact the outer side (13) of the conductor piece (12) on both sides from two vertically opposite directions when it passes through the outlet opening (20);
a forming unit (18) following the outlet opening (20) and comprising a forming opening (24), on the edge of which are multiple forming segments (26), whereby the forming segments (26) are designed and arranged to contact the outer side (13) of the conductor piece (12) on both sides from two vertically opposite directions when it passes through the forming opening (24);
whereby the device (10) comprises at least one pivoting mechanism (34, 36) and at least one compensator device (38, 40) that interact with the forming unit (18) such that the forming segments (26) can tilt relative to the aperture margins (22) around at least one pivot axis (28, Y, Z) that runs orthogonal to the transport direction (X), and can be translationally moved along at least one plane (30), the surface normal of which is the pivot axis (28, Y, Z), and
whereby the device (10) comprises at least one pivoting mechanism (32) that interacts with the forming unit (18) such that the forming segments (26) can tilt around at least one pivot axis (X) which corresponds to the direction of transport, relative to the aperture margins (22), whereby
the device (10) also comprises a detection device (200) arranged and designed to determine an actual form (560) of the conductor piece (12) resulting from the forming method through machine viewing after the conductor piece (12) has passed through the forming unit (18).

10. Device (10) as per the preceding claim, characterized in that the device (10) comprises a control device (300) designed and configured to specify the forming influences exerted on the conductor pieces (12) via the forming device (18), whereby the control device (300) is also designed and configured to conduct a method as per one of the claims 1 through 8.

11. Device (10) as per one of the two preceding claims, characterized in that the detection device (200) is configured and arranged to determine the actual form (560) of a formed conductor piece (12) when it protrudes from the forming segments (26) of the forming unit (18).

12. Device (10) as per one of the two preceding claims, characterized in that the detection device (200) is configured and arranged to determine the actual form (560) of a formed conductor piece (12) after completion of the forming of the conductor piece (12).
